(19) United States
(12) Patent Application Publication
(10) Pub. No.: US 2026/0247386 A1
(43) Pub. Date: Aug. 20, 2026

(54) METHODS FOR FACILITATING UPLINK RESOURCE ALLOCATION IN WIRELESS COMMUNICATION

(71) Applicant: Sony Group Corporation, Tokyo (JP)

(72) Inventors: Anders BERGGREN, Lund (SE); Torgny PALENIUS, Barsebäck (SE); Svante ALNAS, Lund (SE); Shin Horng WONG, Basingstoke (GB); Vivek SHARMA, Basingstoke (GB); Yassin Aden AWAD, Basingstoke (GB); Yuxin WEI, Basingstoke (GB)

(21) Appl. No.: 19/156,324

(22) PCT Filed: Dec. 8, 2023
(86) PCT No.: PCT/EP2023/084977

§ 371 Date: Aug. 13, 2025

(30) Foreign Application Priority Data
Feb. 24, 2023 (SE) 2350215-6

(51) Int. Cl. H04W 72/21; H04W 28/02

(52) U.S. Cl. CPC H04W 72/21; H04W 28/0278

(57) ABSTRACT

An access node of a wireless network, comprising logic configured to allocate resources for uplink transmission from a user wherein the logic is configured to: obtain information, from a report received from the UE related to buffered data forming a subset of a data set for uplink transmission from the UE, wherein said information is indicative of remaining data to be transmitted of the data set; control transmission, to the UE, of a message indicative of a grant of resources for uplink transmission of at least the buffered data.

### TECHNICAL FIELD

This disclosure is related to wireless communication between a wireless device and a wireless network. Specifically, solutions are provided for facilitating and managing resource allocation for uplink transmission from the wireless device of data forming part of a larger set of data which is inter-dependent.

### BACKGROUND

Various protocols and technical requirements for wireless communication have been standardized under supervision of inter alia the 3rd Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network, also referred to as RAN (Radio Access Network), including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication.

In the legacy 5G system, traffic with known periodicity and packet size, e.g., voice, is supported using SPS PDSCH (Semi-Persistent Scheduling, Physical Downlink Shared Channel) and CG PUSCH (Configured Grant, Physical Uplink Shared Channel). These types of scheduling of data communication have evolved throughout different releases (Rel) of the 3GPP specifications. In this context, repetitive scheduling may be configured with a period of a certain number of subframes or slots.

While wireless network specifications were originally developed to support voice traffic, communication of data between the UE and the wireless network is nowadays the dominating use case. 5G NR (New Radio) was introduced to support different types of service categories, including eMBB (Enhanced Mobile Broadband) for high data rates, URLLC (Ultra Reliable Low Latency Communications) for low latency and/or high reliability, and mMTC (Massive Machine-Type Communications) for a high number of low-complexity devices. As capacity increases, new types of data transfer and new purposes for data communication continue to emerge. For example, Extended Reality (XR) refers to various types of augmented, virtual, and mixed environments, where human-to-machine and human-to-human communications are performed with the assistance of handheld and wearable end user devices (UEs). XR covers several applications, such as Virtual Reality (VR), Augmented Reality (AR), and Cloud Gaming (CG), in which the main characteristics are requiring relatively high data rates and low latency. Hence, 5G NR was not designed to support the combination of the aforementioned requirements which are suitable for XR applications. In other words, XR may not be optimally operated in a 5G NR network, such as being unable to reach the required data rate/latency. Operating an XR application using legacy service categories may also result in high UE energy consumption, thus reducing user experience (e.g., short battery life and/or heating). XR applications, however, has a unique characteristic that the traffic pattern is deterministic (i.e., certain periodicity and certain number of traffic flows). There are also some other applications with multiple data streams requiring different characteristics that are relevant, like factory automation, remote machine operation, UAV operation, or just to differentiate between video and audio.

For various applications, such as XR and media services, certain data may comprise groups or chunks of data which are inter-dependent. This is referred herein as a data set. In some examples of 3GPP terminology, such a data set may be referred to as a PDU (Protocol Data Unit) Set, which as such comprises a group of packets used to carry inter-dependent payload, such as e.g., a frame, video slice/tile, audio samples, haptics application data or remote control data. Hence the groups of packets within the PDU Set have inherent dependency on each other in the media layer. In the media layer, packets in such a PDU Set are therefore decoded/handled as a whole. For example, the frame/video slice may only be decoded in case all of the packets carrying the frame/video slice are successfully delivered. A frame within a GOP (Group of Pictures) can only be decoded by the client in case all frames on which that frame depends are successfully received. Hence, the groups of packets within the data set, e.g., PDU Set, have an inherent dependency on each other in the media layer. Without considering such dependencies between the packets, scheduling may be performed with low efficiency. For example, packets may be randomly dropped while attempts to deliver other packets of the same frame/video slice are still made, even though such other packets are useless to the receiving part if the whole data set is not delivered. This results in waste of radio resources.

In some aspects, a data set of inter-dependent data is thus characterized in that all data of the data set must be successfully delivered for a data object, such as a video frame, represented by the data set to be decoded properly. This may be particularly challenging for UL data, since resources for such transmission are scheduled by the access network.

### SUMMARY

An overall objective of the proposed method is to provide solutions for configuring uplink communication of a data set comprising inter-dependent data. An aspect of this objective is to provide solutions that facilitate successful transfer of all data of a common data set, to counteract latency problems or allocation overhead caused by the legacy process of requesting for resource and receiving an UL grant for each fraction of data from the data set. The proposed solution is defined by the terms of the independent claims, while further advantageous embodiments are set out in the dependent claims and in the detailed description.

According to a first aspect, the proposed solution relates to a method carried out in an access node of a wireless network for managing resource allocation for uplink transmission from a UE, wherein the method comprises:
receiving, from the UE, a report related to buffered data forming a subset of a data set for uplink transmission from the UE, wherein said report comprises information indicative of remaining data to be transmitted of the data set;
transmitting, to the UE, a message indicative of a grant of resources for uplink transmission of at least the buffered data.

According to the independent claims, a related method for the UE is provided, and additionally an access node and a UE configured accordingly.

Based on the proposed solution, a mechanism is obtained for enhanced reporting from the UE which allows for improved resource allocation and utilization for uplink transmission of a data set of inter-dependent data. As a result, resource wastage may be minimized and improved energy conservation on the UE side may be obtained.

### BRIEF DESCRIPTION THE DRAWINGS

FIG. 1 schematically illustrates an implementation of a wireless communication system, in which a UE communicates with an access node of a wireless network by radio communication. Various entities of a core network of the wireless network are further shown.

FIG. 2 schematically illustrates a UE configured to operate with the wireless network according to various examples.

FIG. 3 schematically illustrates an access node configured to operate in the wireless network for communication with the UE according to various examples.

FIG. 4 is a flowchart of a method for operating an access node according to various examples of the proposed solution.

FIG. 5 shows a method carried out in a UE according to various examples of the proposed solution.

FIG. 6 illustrates signaling and data flow in one example making use of the proposed solution.

### DETAILED DESCRIPTION

In the following description, for the purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

Before presenting aspects and examples of the proposed solution, context and devices for use of the proposed solution will be briefly described with reference to the drawings. The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

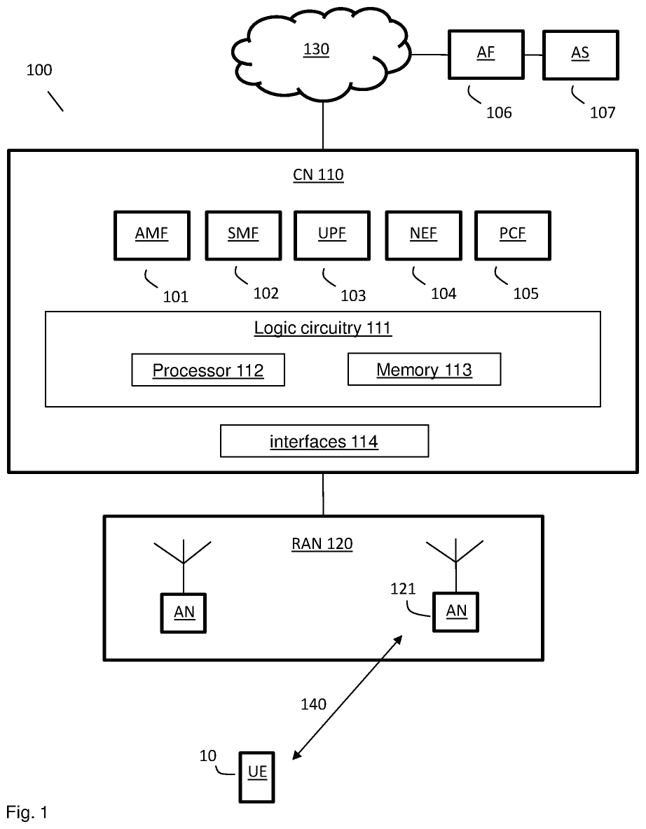

FIG. 1 illustrates a high-level perspective of operation of a UE 10 in a wireless system, configured to communicate with a wireless communication network 100, denoted wireless network 100 for short herein. FIG. 1 is useful for context of the proposed solution and illustrates various entities and functions which cooperate in wireless system.

The wireless network 100 may be a radio communication network 100, configured to operate under the provisions of 5G as specified by 3GPP, according to various examples, or further generations.

The wireless network 100 may comprise a core network (CN) 110, connectable to an external network 130 such as the Internet. The core network may comprise a plurality of core network nodes, which realize logical functions. For the example of a 5G system, as illustrated, this may, inter alia, include the Access and Mobility Management Function (AMF) 101, a Session Management Function (SMF) 102, a User Plane Function (UPF) 103, a Network Exposure Function (NEF) 104, a Policy Control Function (PCF) 105, all of which are legacy functions of the 5G system (5GS). One or more Application Functions (AF) 106 may be deployed outside of the 5G system i.e., as an application running on an application server (AS) 107 connected to the external network e.g., the Internet, which application server provides data for communication in the wireless system. Operators may deploy the AF 106 as trusted or non-trusted. A trusted AF 106 may have access to all interface with the CN 110 while an un-trusted must access anything inside the CN via the NEF 104.

The wireless network 100 further comprises an access network 120, comprising a plurality of access nodes (AN) including access node 121, configured for radio communication with wireless devices including the UE 10.

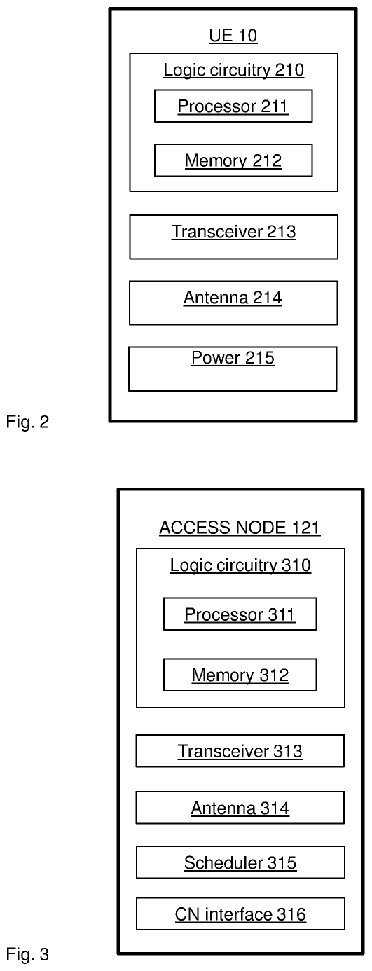

FIG. 2 schematically illustrates an example of the UE 10 for use in a wireless network 100 as presented herein and configured for carrying out various method steps as outlined. Some relevant elements or functions of the UE 10 are shown in the drawing. The UE 10 may however include other features and elements than those shown in the drawing or described herein, such as a casing, a user interface, sensors, etc., but these are left out for the sake of simplicity.

The UE 10 comprises a radio transceiver 213, also referred to herein as modem 213, for communicating with other entities of the radio communication network 100, such as the access node 121, in one or more frequency bands. The transceiver 213 may thus include a receiver chain (Rx) and a transmitter chain (Tx), for communicating through at least an air interface, referred to as Uu in 3GPP. The transceiver 213 may be or comprise a modem configured to encode, transmit, receive and decode data using radio waves.

The UE 10 may further comprise an antenna system 214, which may include one or more antennas, antenna ports or antenna arrays. In various examples the UE 10 is configured to operate with a single beam, wherein the antenna system 214 is configured to provide an isotropic gain to transmit radio signals. In other examples, the antenna system 214 may comprise a plurality of antennas for operation of different beams in transmission and/or reception. The antenna system 214 is connected to the transceiver 213.

The UE 10 further comprises logic circuitry 210 configured to control data and signal communication via the radio transceiver on a physical channel 140 to a serving access node 121 of the wireless network 100. The logic circuitry is further configured to control the UE to carry out any of the steps associated with the proposed solution as outlined herein.

The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

The UE 10 further comprises a power supply 215 (e.g., a battery) that provides energy to the other components of the UE 10.

FIG. 3 schematically illustrates a radio node in the form of an access node 121 of the wireless network 100 as presented herein, and for carrying out the method steps as outlined. An access node 121 may have one or more transmission and reception point(s) TRP(s). In various examples, the access node 121 is a radio base station for operation in the radio communication network 100, to serve one or more radio UEs, such as the UE 10.

The access node 121 may comprise a wireless transceiver 313, such as a radio transceiver for communicating with other entities of the radio communication network 100, such as the terminal 10. The transceiver 313 may thus include a radio receiver and transmitter for communicating through at least an air interface. The transceiver may comprise a radio modem.

The access node 121 may further comprise, or be connected to, an antenna 314, which may include an antenna array. The antenna is connected to the transceiver 313.

The access node 121 further comprises logic circuitry 310 configured to control the access node 121 to communicate with the UE 10 via the radio transceiver 313 on the physical channel 140. The logic circuitry 310 may realize a scheduler for scheduling communication of a data set according to the solutions proposed herein, and for configuring the UE to operate according to the scheduling, based on a related QoS.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.). The memory storage 312 is configured for holding computer program code, which may be executed by the processing device 311, wherein the logic 310 is configured to control the access node 121 to carry out any of the method steps as provided herein. Software defined by said computer program code may include an application or a program that provides a function and/or a process. The software may include device firmware, an operating system (OS), or a variety of applications that may execute in the logic 310.

The access node comprises a scheduler 315, or scheduling function, which as such may be realized by operation of program code in the logic circuitry 310. The scheduler is operated for allocating resources for communication using the transceiver 313 over radio, such as with the UE 10. Each resource may in this context be indicative of a unit of time and/or frequency of a radio frame structure, according to the established art.

The access node 121 may further comprise an interface 316, configured for communication with the core network 110.

Various aspects of the proposed solution will now be described. It shall be noted that examples will primarily be given with reference to video data and XR applications. While the proposed solution is useful in that context, it shall be noted that the broad aspects of the proposed solution are not restricted thereto.

In current 5GS, the QoS Flow is the finest granularity of QoS differentiation in a PDU Session. The 5G QoS characteristics is determined by the 5QI, 5QI (5G QOS Identifier). The 5QI is a pointer to a set of QoS characteristics such as priority level, packet delay or packet error rate, etc. This implies that each packet in a QoS flow is treated according to the same QoS requirements. In order to further clarify problems associated with legacy QoS Flow comprising constant QoS requirements, reference can be made to video coding. In video coding, a group of pictures (GOP) is commonly used. The GOP is a collection of successive pictures within a coded video stream. A GOP can contain the following picture types:
I frame (intra coded picture, also called keyframe)—a picture that is coded independently of all other pictures. Each GOP begins (in decoding order) with this type of picture.
P frame (predictive coded picture)—contains motion-compensated difference information relative to previously decoded pictures. In older designs such as H.262/MPEG-2 each P frame can only reference one picture, and that picture must precede the P frame in display order as well as in decoding order and must be an I or P frame. These constraints do not apply in newer standards and HEVC (High Efficiency Video Coding).
B frame (bi-predictive coded picture)—contains motion-compensated difference information relative to previously decoded pictures. In older designs such as MPEG-1 and H.262/MPEG-2, each B frame can only reference two pictures, the one which precedes the B frame in display order and the one which follows, and all referenced pictures must be I or P frames. These constraints do not apply in newer standards H.264/MPEG-4 AVC and HEVC.
D frame (DC, direct coded picture)—serves as a fast-access representation of a picture for loss robustness or fast-forward. D frames are only used in MPEG-1 video.

An I frame indicates the beginning of a GOP. Afterwards several P and B frames follow. XR transmission typically involves video transmission. A video transmission, particularly a video transmission with high quality, may require large packet size. A large packet size is typically divided into sub-packets or PDUs, belonging to a PDU set. Each sub-packet is transmitted in a wireless channel 140 from the access node 121 to the UE 10, or vice versa. It may occur that one or more sub-packets are not received at the receiver side, for example, due to a bad wireless channel condition. For video transmissions, usually a frame needs to be delivered in time or the whole frame will be discarded since there is no time for retransmissions. So, to make sure all sub-packets belonging to the same data set, e.g., video frame, can be delivered, and to avoid potential retransmission, and to utilize radio resources efficiently, an improved mechanism is needed.

The proposed solution provides a mechanism that entails that enhanced information is provided from the UE 10 to access node 121 in conjunction with a request for resources for UL transmission. This information may be collected from the application layer or be determined in the modem 213. The solution is particularly advantageous for use in a context of the application providing a plurality of inter-dependent data packets which must all be successfully received in the access node 121 to enable decoding, such as for a frame of video data. Such inter-dependent data can be referred to as a data set, which may be encoded as a PDU set.

For each frame, e.g. generated at 60 FPS (frames per second), knowledge, estimation or prediction of the size of the whole data set that is to be transmitted, and optionally when in time it will be transmitted, in the uplink may in some examples be delivered from the UE XR application (Media Access Function) to the modem 213 so that for each “chunk” of data delivered from the application layer of a complete data set, there is an indication of remaining data for that (“Intra PDU set indication”).

In some examples, also a prediction of the next data (PDU) set size (Inter PDU set predictability) is delivered from the XR application or Media Access Function to the modem 213, wherein the modem 213 is configured to send information comprising a parameter indicative of predicted data of the next data set to the access node 121, such as predicted data size of the next data set.

The scheduler 315 in the access node 121 may thus take the additional information into consideration when allocating UL resources for the UE 10. This may entail configuring resources for a plurality of UL transmission occasions, based on the received information.

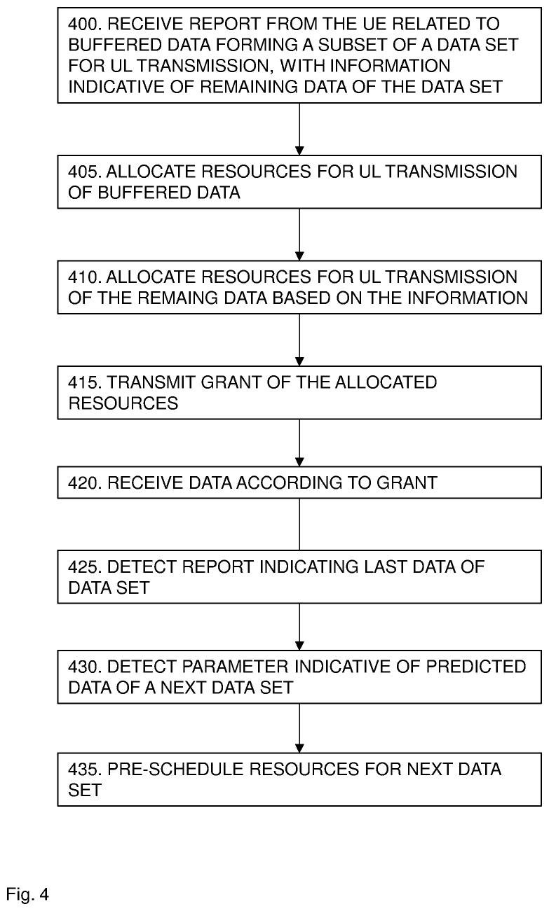

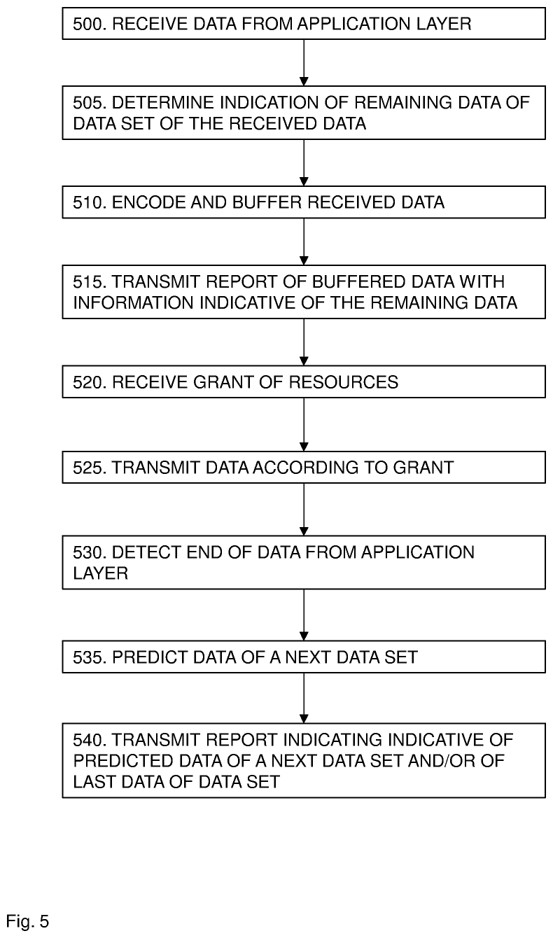

With reference to the flowcharts of FIGS. 4 and 5, methods according to various examples of the proposed solution will now be described, as carried out in the access node 121 and in the UE 10, respectively. The access node 121 can thus be seen as a serving access node 121 of the RAN 120 for the UE 10. Further details and examples will follow, where reference will occasionally be made back to the flowcharts of FIGS. 4 and 5, for consistency.

FIG. 4 shows a flowchart of a method carried out in the access node 121 of the wireless network 100 for managing resource allocation for UL transmission from the UE 10. It shall be noted that the flowchart includes various steps that may be carried out in conjunction with the proposed solution, and some which may be optionally included in the proposed solution. In other words, it is not mandatory that all steps are carried out. According to an aspect related to the method of FIG. 4, the proposed solution provides an access node 121 comprising logic 310 configured to control the access node to carry out any of the steps of FIG. 4, using transceiver 313.

In step 400 the access node 121 receives, from the UE 10, a report related to buffered data forming a subset of a data set for uplink transmission from the UE, wherein said report comprises information indicative of remaining data to be transmitted of the data set. In this context, the logic 310 may obtain the information from the report as received by the transceiver 313.

The report thus comprises an indication of the buffered data, such as a Buffer Status Report (BSR). In addition, the report comprises information indicative of further data of the data set of which the buffered data forms a subpart.

In step 405 the access node 121 may thus allocate resources for UL transmission of the buffered data, according to the report.

In step 410, the access node 121 may further allocate resources for UL transmission of all or part of any remaining data of the data set, for future UL transmission, e.g., data of the data set that has not yet been delivered from the XR application and which is therefore not yet buffered.

In step 415, the access node transmits, to the UE 10, a message indicative of a grant of resources for uplink transmission of at least the buffered data allocated in step 405. The access node 121 may further grant resources for the all or parts of the remaining data, based on the received information.

A benefit of this approach is that instead of allocating a fixed-size periodic configured grant (CG) resources, the access node 121 may allocate variable size resources depending on the size of actual data in a PDU set or chunk of data while taking into account the time budget, such as a time budget that aims at completing UL transmission of the complete data set before the application layer provides the next data set (such as the next frame) to the modem 213 in the UE 10. Hence, instead of transmitting a PDU set over e.g., 4 occasions of CG resources of equal size as in the legacy, which may not provide the required or suitable resources to complete the PDU set, this approach allows 4 occasions of variable size depending on the size of PDUs in a PD/U set or chunks of data which might consume less resources than fixed size allocations and help avoid resource wastage and increase system capacity. Alternatively, if CG configuration has e.g., 4 occasions within a period, but only two occasions can be used/occupied, this approach allows the UE 10 to indicate to the access node 121 that it would only need two occasions with certainty. Based on this indication, the access node 121 can decrease/increase/keep the number of occasions in a period or decrease/increase/keep the number Resource Blocks in the frequency domain by reconfiguring the CG parameters via RRC signaling. Hence, this would help the access node to avoid resource wastage and increase the system capacity. In other words, the proposed solution provides that, instead of having fixed allocation with a size which will support any possible Max PDU Set size, a variable allocation depending on the actual size of the current PDU Set is made possible, which will save allocated resources. The allocation will thereby be based on the information provided in or in conjunction with the BSR report.

For dynamic grant (DG) scheduling, the approach of the proposed solution will provide the access node scheduler 315 with an estimate of how much data is expected from the UE 10 in the near future, so that the access node 121 can schedule the UE 10 dynamically taking into account the time budget (or remaining time). Hence, this would help to deliver the whole data set, e.g., XR data, on time to the network and as a result would minimize the risk of dropping the current data set, e.g., XR PDU set.

Step 420 indicates that the access node 121 receives data from the UE 10 on the allocated resources, which is a continuation of the proposed solution related to the resource allocation. This may thus, as exemplified above, include a plurality of occasions of UL transmission.

In some examples, each occasion of UL transmission 420 (of a burst of data transmissions for the whole data set) may comprise reception of information indicative of remaining data of the data set, as exemplified herein, such as size and/or timing of a next UL transmission or of all the remaining data of the data set. In some scenarios, improved knowledge/estimation/prediction of size and/or timing of remaining data may have been determined in the UE 10, e.g., obtained from the application layer, after transmission of the report and information associated with a previous (e.g., first) UL data transmission of the same data set.

Step 425 indicates that in some examples, a report (e.g., BSR) related to UL data may comprise a parameter indicative of the buffered data being the last of the data set, such as a last PDU of a PDU set. This information may assist the access node 121 in determining that no further UL transmission occasions are required to the current data set. If any such further occasions are already scheduled, the related allocated resources may be released, to minimize wastage of radio resource.

Step 430 indicates that in some examples, the information provided by the UE 10 may comprise a parameter indicative of predicted data of a next data set. This may e.g. include an indication of predicted size of the next data set (e.g. PDU set), which may be referred to as Inter PDU set predictability. In some examples, this indication is transmitted by the UE 10 with the BSR, such as in the last BSR of the current data set.

This next data set size can be predicted based on PDU statistics or known sequence of data chunks of the traffic of a particular current application service. In another example, the next data set size may be predicted by the application layer based on data present in its application layer buffer, waiting for transfer to the modem 213.

In some examples, Artificial Intelligence, for example utilizing a machine learning (ML) model is used to predict the next PDU set size. The ML model may e.g., take training from historical data transmission using the same application. In one example, the ML model is executed on the application layer in the UE 10. In another example, the AI/ML model is stored in the memory storage 212 and run by the processor 211 inside the modem 213 on the input data received from the application layer, to predict the amount of data for future transmissions of further PDU set(s) related to the XR application.

Step 435 indicates that the access node 121 may pre-schedule resources for use to obtain the next data set, based on the received prediction. This provides the benefit of improving latency for at least the first UL transmission of the next data set. Moreover, overall resource scheduling is facilitated where the access node makes resource allocation and scheduling for multiple UEs.

FIG. 5 shows a flowchart of a method carried out in the UE 10 for facilitating resource allocation in the access node 121 for uplink transmission from the UE 10. It shall be noted that the flowchart includes various steps that may be carried out in conjunction with the proposed solution, and some which may be optionally included in the proposed solution. In other words, it is not mandatory that all steps are carried out. According to an aspect related to the method of FIG. 5, the proposed solution provides a UE 10 comprising logic 210 configured to control the UE 10 to carry out any of the steps of FIG. 5, using transceiver 213.

It shall be noted that various aspect and examples of the proposed solution are described in conjunction with FIG. 4, which are also applicable to the method carried out in the UE 10 and are therefore not always repeated with reference to FIG. 5.

In step 500 the UE 10 receives data from an application layer of the UE 10. The application may, e.g., be an XR video application which operates to transmit video data from the UE 10 to or via the wireless network 100, and typically also to receive data from the wireless network 100. The application may in this context provide data with a certain periodicity (e.g., 60 FPS), where all or at least a sufficient number of data packets of a data set must be successfully provided to the wireless network in order for that data to be decoded and useful.

In step 505, an indication of remaining data of the data set, of which the received data is a subset, is determined. This may e.g., include determining size and/or timing of data of a complete frame, i.e., the whole data set, or alternatively the size of at least one subsequent chunk of data to be transmitted which is part of the whole PDU set. Based on this indication, the UE 10 is configured to be able to subsequently provide an indication of remaining data (“Intra PDU set remains”) to the access node. The determination may be known information, where available, obtained from the application. In another example, the information may be an estimation, or prediction, provided by the application or run in the modem 213, e.g., based on an ML model as described above. Information to be transmitted to the access node, indicative of the remaining data, may be configured by the UE, e.g., by including a parameter indicative of the remaining data, in header information or as appended information to be sent in conjunction with the BSR.

Step 510 indicates that the data received from the application layer may further be encoded and buffered in the UE 10.

Step 515 indicates that the UE 10 transmits a report related to buffered data forming a subset of the data set for uplink transmission, wherein said report comprises information indicative of remaining data to be transmitted of the data set. In this context, the logic 210 may control transmission to the access node 121 using the transceiver/modem 213. This transmission is sent as a request for UL resources, such as a scheduling request.

Step 520 indicates that the UE receives a grant of resources, such as CG or dynamic grant, from the access node 121. Resources of the grant may have been allocated by the access node 121 based on the reported buffered data for UL transmission and for all or part of any remaining data of the data set, for future UL transmission.

A benefit of this approach is, as indicated, that grant of resource allocation may be obtained that may minimize wastage of resources, while being adapted to ensure that the whole data set is timely transmitted.

Step 525 indicates that the UE 10 transmits data to the access node 121 on the allocated resources, which is a continuation of the proposed solution related to the resource allocation as such. This may thus, as exemplified above, include a plurality of occasions of UL transmission.

Step 530 indicates that in some examples, the UE 10 may detect an end, such as a last PDU, of the data set. This information may be obtained from the application layer. In this scenario, the UE may be configured to transmit a report (e.g., BSR) related to UL data with a parameter indicative of the buffered data being the last of the data set, such as a last PDU of a PDU set.

Step 535 indicates that in some examples, the UE 10 is configured to predict data of a next data set. This may, e.g., include predicted size of the next data set (e.g., PDU set), which may be referred to as Inter PDU set prediction. Further examples and features in this context are described with reference to FIG. 4, such as employment of artificial intelligence by machine learning.

Step 540 indicates the example of the UE 10 transmitting information indicative of end of data, as determined in step 530, and/or indicative of predicted data of a next data set.

As noted, various aspects of the proposed solution relate to providing enhanced information from the UE 10 the access node 121 for facilitating resource allocation and scheduling. This involves providing information to the access node 121, indicative of remaining data to be transmitted of the data set, such as remaining data of a complete frame. In some scenarios, the UE 10 may have complete knowledge of the remaining PDU set size or the subsequent PDU set size. In such cases, the information may indicate a true value of size and/or timing of the remaining data to be transmitted. In other examples, the information is indicative of an estimate or prediction of size and/or timing of the remaining data.

As an example, which is useful for operation of the proposed solution, determination of the remaining data of the data set may in some examples involve Media Unit Identification, which may be a functionality executed by the logic circuitry 210 of the UE 10. Media Unit Identification detects media specific properties of packets according to PDU Families, as given from the codecs, to which it belongs. Media Unit Identification may utilize techniques such as DPI (Deep packet inspection), and examination of RTP (Real-Time Protocol) headers to determine media units associated with a packet. Packets belonging to a PDU set can be identified by inspecting a combination of fields in the RTP header (sequence number, timestamp, M bit) and RTP header extensions, e.g., IETF Frame Marking RTP Extension header, etc., and the media payload header, e.g., RTP payload NAL (Network Abstraction Layer) Unit Type field. In this context, the first packet of a PDU set has an RTP header with new timestamp, a new Type field in NAL unit header and follows the sequence number of the packet with the RTP header M-bit set to 1 (i.e., sequence number is 1 greater than the packet with M-bit set to 1). Detection of the first packet may need a combination of fields since timestamp may not be incremented for enhancement layers (PDU set). If an RTP experimental extension header is present, the S-bit is set to 1. These fields can identify the start of a PDU set. The last packet of a PDU set has the RTP header M-bit set to 1 or precedes packet/sequence number with new timestamp. If an RTP experimental extension header is present, the E-bit is set to 1.

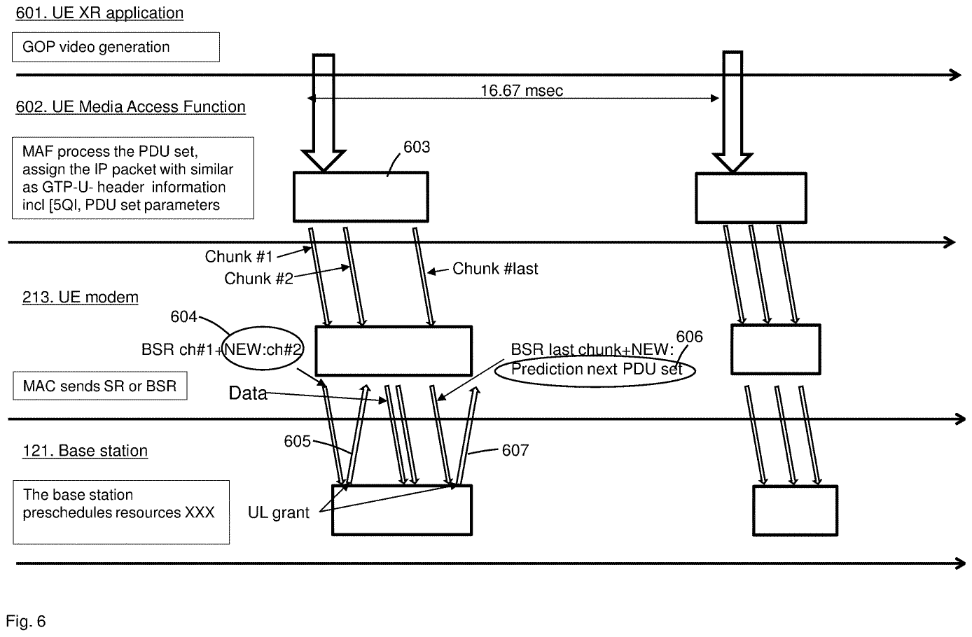

Reference will now be made to FIG. 6, for description of various examples of the proposed solution. This drawing schematically shows high-level functionality and signaling flow of an example of the proposed solution, where the horizontal axis indicates time and where data and signaling is carried out between different functions and entities in the vertical direction. Operation in the UE 10 may be carried out by the logic circuitry 210, by means of the processor 211 running software code of the memory storage 212 to carry out the functions described.

The example shown in FIG. 6 is provided for an XR application 601 running in the UE 10, as indicated at the top level. The XR application provides GOP video generation, with a frame rate of 60 FPS, which amounts to a period of 16.67 ms between frames.

A Media Access Function (MAF) 602 in the UE 10 receives XR data from the XR application 601. This corresponds to step 500 of FIG. 5. Each box 603 indicates operation related to one data set, such as a PDU Set, associated with one frame received from the XR application 601. XR source management may provide raw media and meta data to the MAF 602. The MAF may comprise or be connected an encoder, operating e.g., a video codec, and may further be configured for meta data format handling.

As described above, information is obtained indicative of remaining data to be transmitted of the PDU set, such as size and/or timing of any further known or predicted further chunks of data to be received from the application. This information may be obtained from the application layer, such as in said meta data, or be later determined in the modem 213, as exemplified. This corresponds to step 505.

From the MAF 602 in the UE, PDU set information, e.g. corresponding to GTP-U header information, is conveyed down to the UE modem 213. The MAF 602 may provide data in chunks to the modem 213, e.g., output from an encoder. In this context, each chunk may require one UL transmission occasion. Each chunk [Chunk #1 to Chunk #last] may contain one or more PDUs of the same PDU set. The number of chunks may be dependent on inter alia the size of the PDU set, and of capability of the encoder in the UE 10. This step may correlate with step 510.

The UE modem 213 provides a report, such as a BSR, related to buffered data forming a subset of the PDU set for uplink transmission from the UE. Said report further comprises information 604 indicative of remaining data to be transmitted of the PDU set, such as about subsequent data transmission needed related to same PDU set, i.e., within the same 60 FPS/16.67 ms period. The information 604 may be provided as fields in the BSR, or as separate data. This corresponds to steps 400 and 515.

According to some examples, the information 604 comprises a parameter indicative of size of remaining data to be transmitted of the data set.

This may indicate the total number of remaining data, e.g., remaining number of bytes, of the same (current) data set. In an alternative example, the parameter indicative of size of remaining data may indicate how many more UL transmission occasions (chunks) that is required or estimated to transmit the whole current data set. According to yet another alternative example, the information 604 is indicative of at least one data unit of the buffered data, such as a PDU sequence number within the data (PDU) set, useful in combination with indicated total number, quantity, of data units of the data set, or in combination with a parameter indicative of remaining number of data units to be transmitted of the current data set.

According to some examples, the information 604 is indicative of size of data to be buffered for a next uplink transmission of data of said data set. This example is indicated in FIG. 6, where BSR ch#1 includes new information 604 related to ch#2. According to some examples, the BSR of each transmission occasion ch#n comprises information 604 indicative of size of data to be buffered for a next uplink transmission of data of said data set of the next occasion ch#n+1.

In some examples, the information 604 is indicative of timing of transmission of said data set. This may refer to a required maximum time within which to schedule transmission occasions for the whole data set. In another example, this may indicate preferred timing of the next uplink transmission ch#2 of data of said data set.

According to some examples, the information 604 is indicative of burst uplink transmission of the data set. This provides information to the access node 121 that more than the currently buffered data is required to be transmitted and may trigger allocation of resources for further transmission occasions.

The access node responds with a message 605, providing grant of resources for at least the buffered data indicated in the BSR. In addition, the access node 121 provides grant for resources for further UL transmission occasions, based on the obtained information 604. This corresponds to steps 415 and 520.

Data is thereafter transmitted in the allocated resources, as indicated in FIG. 6, from the modem 213 to the access node. This corresponds to steps 420 and 525.

As described, the UE 10 may in some examples be configured to transmit information 606 which comprises a parameter indicative of predicted data of a next data set. Such prediction has been discussed above and correlates with step 535. This information may be transmitted together with an indication of end of the current data set, determined according to step 525.

The transmission of information 606 which comprises a parameter indicative of predicted data of a next data set corresponds to step 540. This information 606 may be used by the access node 121 to optionally pre-schedule resources for the next data set (e.g., PDU set), e.g., based on the periodicity (frame rate) of the application. This way, a message 607 indicating grant of resources for the next period of the application may be transmitted to the UE 10 prior to the data of that next period having been received in the MAF 602. This corresponds to step 435. This is advantageous from a latency point of view, since it increases the chances of succeeding with complete data set transmission in the next period. In some examples, the parameter indicative of data of a next data set is indicative of predicted data size of the next data set.

The features and examples described herein may be combined in any manner that is not clearly contradictory, or as provided in the appended claims.

1. Method carried out in an access node of a wireless network for managing resource allocation for uplink transmission from a user equipment (UE) wherein the method comprises:
receiving, from the UE, a report related to buffered data forming a subset of a data set for uplink transmission from the UE, wherein said report comprises information indicative of remaining data to be transmitted of the data set;
transmitting, to the UE, a message indicative of a grant of resources for uplink transmission of at least the buffered data.

2. The method of claim 1, wherein said information comprises a parameter indicative of size of remaining data to be transmitted of the data set.

3. The method of claim 1, wherein said information is indicative of size of data to be buffered for a next uplink transmission of data of said data set.

4. The method of claim 1, wherein said information is indicative of timing of transmission of said data set.

5. The method of claim 1, wherein said information comprises a parameter indicative of a size of the data set.

6. The method of claim 1, wherein said information is indicative of at least one data unit of the buffered data and comprises a parameter indicative of a quantity of data units remaining to be transmitted of the data set.

7. The method of claim 1, wherein said information comprises a parameter indicative of a sequence number, in the data set, of at least one data unit of the buffered data.

8. The method of claim 1, wherein said information is indicative of burst uplink transmission of the data set.

9. The method of claim 1, wherein the transmitting comprises transmitting a grant of resources for uplink transmission of a plurality of uplink transmission occasions.

10. The method of claim 8, wherein the information indicative of remaining data to be transmitted comprises a parameter indicative of the buffered data being the last of the data set.

11. The method of claim 1, wherein the information comprises a parameter indicative of predicted data of a next data set.

12. The method of claim 11, wherein said parameter indicative of data of a next data set is indicative of predicted data size of the next data set.

13. The method of claim 1, wherein said report is a buffer status report (BSR).

14. The method of claim 1, wherein said data set is a Protocol Data Unit (PDU).

15. An access node of a wireless network, comprising logic configured to allocate resources for uplink transmission from a user equipment (UE) wherein the logic is configured to:
obtain information, from a report received from the UE related to buffered data forming a subset of a data set for uplink transmission from the UE, wherein said information is indicative of remaining data to be transmitted of the data set;
control transmission, to the UE, of a message indicative of a grant of resources for uplink transmission of at least the buffered data.

16. Method carried out in a user equipment (UE) for facilitating resource allocation in an access node for uplink transmission from the UE, wherein the method comprises:
transmit, to the access node, a report related to buffered data forming a subset of a data set for uplink transmission from the UE, wherein said report comprises information indicative of remaining data to be transmitted of the data set;
receive, from the access node, a message indicative of a grant of resources for uplink transmission of at least the buffered data.

17. The method of claim 16, wherein said information comprises a parameter indicative of size of remaining data to be transmitted of the data set.

18. The method of claim 16, wherein said information is indicative of size of data to be buffered for a next uplink transmission of data of said data set.

19. The method of claim 16, wherein said information is indicative of timing of a next uplink transmission of data of said data set.

20-33. (canceled)
